(19) United States
(12) Patent Application Publication
(10) Pub. No.: US 2017/0264568 A1
(43) Pub. Date: Sep. 14, 2017

(54) COMMUNICATION DEVICE, COMMUNICATION SYSTEM AND COMMUNICATION METHOD

(71) Applicant: FUJITSU LIMITED, KAWASAKI-SHI (JP)

(72) Inventors: TOMOYOSHI FUJIMORI, KAWASAKI (JP); YASUYUKI MITSUMORI, KAWASAKI (JP); KANTA YAMAMOTO, KOKUBUNJI (JP)

(73) Assignee: FUJITSU LIMITED, KAWASAKI-SHI (JP)

(21) Appl. No.: 15/435,911

(22) Filed: Feb. 17, 2017

(30) Foreign Application Priority Data
Mar. 8, 2016 (JP) 2016-044610

(51) Int. Cl. H04L 12/911; H04L 12/811; H04L 12/863; H04L 12/935

(52) U.S. Cl. CPC H04L 47/828; H04L 49/3027; H04L 47/38; H04L 47/623

(57) ABSTRACT

There is provided a communication device in a communication system in which a plurality of communication devices are coupled in series, the communication device including: a memory; a processor coupled with the memory and the processor configured to: receive a control signal included in a signal transmitted from a first communication device of the plurality of communication devices, control an output band in which the communication device transmits the signal, based on a weight value included in the control signal received, update the weight value, and transmit the signal including the control signal including the weight value updated, to a second communication device of the plurality of communication devices through the output band controlled.

### CROSS-REFERENCE TO RELATED APPLICATION

This application is based upon and claims the benefit of priority of the prior Japanese Patent Application No. 2016-044610 filed on Mar. 8, 2016, the entire contents of which are incorporated herein by reference.

### FIELD

The embodiments discussed herein are related to a communication device, a communication system and a communication method.

### BACKGROUND

There is a communication system in which a plurality of communication devices in a network are connected in series. When transmitting data to an upper-stage communication device, a lower-stage communication device may transmit the data to the upper-stage communication device as a destination through an upper communication device connected to the own device. Hereinafter, the state where the plurality of communication devices are connected in series is expressed as a stack, the connection configuration is expressed as a stack connection, and the number of devices connected in a stack is expressed as the number of stack stages.

Related techniques are disclosed in, for example, Japanese Laid-open Patent Publication Nos. 2011-097507, 2001-320420, and 2006-101510.

### SUMMARY

According to an aspect of the invention, a communication device in a communication system in which a plurality of communication devices are coupled in series, the communication device includes: a memory; a processor coupled with the memory and the processor configured to: receive a control signal included in a signal transmitted from a first communication device of the plurality of communication devices, control an output band in which the communication device transmits the signal, based on a weight value included in the control signal received, update the weight value, and transmit the signal including the control signal including the weight value updated, to a second communication device of the plurality of communication devices through the output band controlled.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view illustrating an example of a communication system according to a first embodiment;

FIG. 2 is a block diagram illustrating an example of a card configuration within a communication device according to the first embodiment;

FIG. 3 is a block diagram illustrating an example of a configuration within a communication device;

FIG. 4 is an explanatory view illustrating an example of a functional configuration within an SW card;

FIG. 5A is an explanatory view illustrating an example of a format configuration of a VLAN tagless frame;

FIG. 5B is an explanatory view illustrating an example of a format configuration of a VLAN tag frame;

FIG. 6 is an explanatory view illustrating an example of a format configuration of a BC frame;

FIG. 7 is an explanatory view illustrating an example of setting contents of a transfer rate ratio for each communication device within a communication system;

FIG. 8 is a sequence diagram illustrating an example of a processing operation of communication devices # 0, # 1 and # 2 related to a stage number update process;

FIG. 9 is a sequence diagram illustrating an example of a processing operation of communication devices # 0, # 1 and # 2 related to the stage number update process;

FIG. 10 is a flowchart illustrating an example of a processing operation of a reception processor within a communication device related to a reception process;

FIG. 11 is a flowchart illustrating an example of a processing operation of an FPGA within a communication device related to a first setting process;

FIG. 12 is a flowchart illustrating an example of a processing operation of an FPGA within a communication device related to a reading process;

FIG. 13 is an explanatory view illustrating an example of a functional configuration within an SW card in a communication device according to a second embodiment;

FIG. 14 is an explanatory view illustrating an example of setting contents of a transfer rate ratio for each communication device within the communication system according to the second embodiment;

FIG. 15 is a flowchart illustrating an example of a processing operation of an FPGA within a communication device related to a second setting process;

FIG. 16 is an explanatory view illustrating an example of a communication device that executes a communication program; and

FIG. 17 is an explanatory view illustrating an example of setting contents of a transfer rate ratio for each communication device within a communication system.

### DESCRIPTION OF EMBODIMENTS

In a communication system with a stack connection, when the stack connection is performed without specifically setting a band control for an uplink direction from a lower-stage communication device to an upper-stage communication device, the ratio of data amount transmittable from the lower-stage communication device to the upper-stage communication device is reduced at a lower-stage communication device.

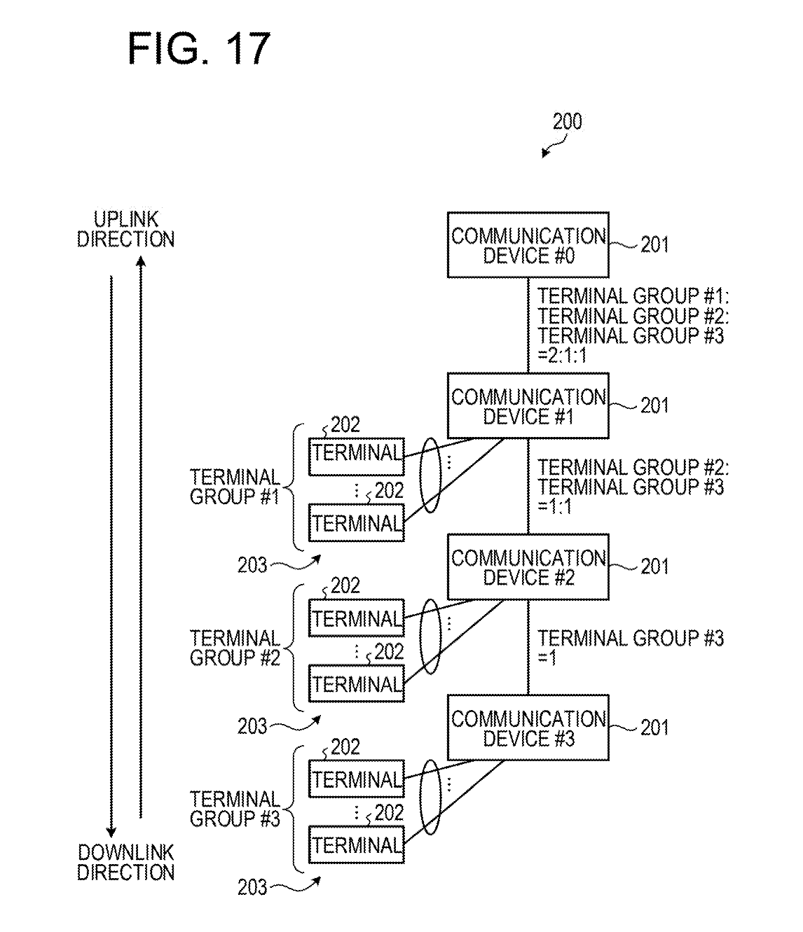

FIG. 17 is an explanatory view illustrating an example of setting contents of a transfer rate ratio for each communication device within a communication system. The communication system 200 illustrated in FIG. 17 includes a communication device #0_201 to a communication device #3_201. In the communication system 200, the communication device #1_201 is connected under the upper-stage communication device #0_201, the communication device #2_201 is connected under the communication device #1_201, and the communication device #3_201 is connected under the communication device #2_201. The communication device #1_201 is connected to accommodate a terminal group #1_203 including a plurality of terminals 202. The communication device #2_201 is connected to accommodate a terminal group #2_203 including a plurality of terminals 202. The communication device #3_201 is connected to accommodate a terminal group #3_203 including a plurality of terminals 202.

When transmitting data to the communication device #0_201, the lowermost-stage communication device #3_201 transmits the data to the upper-stage communication device #2_201. When transmitting data to the communication device #0_201, the communication device #2_201 transmits the data to the upper-stage communication device #1_201. Then, the communication device #1_201 transmits the data to the communication device #0_201.

It is assumed that the communication system 200 sets the band control in the uplink direction of each communication device 201 as a best effort type and transmits frames in the order of arrival. Then, it is assumed that each communication device 201 is statistically multiplexed such that a band amount in the uplink direction becomes smaller than a band amount in the downlink direction. A frame indicates a packet signal transmitted between communication devices.

In this case, when the communication device #2_201 transmits data of the terminal group #3_203 and the terminal group #2_203, which is addressed to the communication device #0_201, to the communication device #1_201, the transfer rate ratio of the terminal group #2_203 to the terminal group #3_203 becomes 1:1. Here, since the transfer rate ratio of the terminal group #2_203 to the terminal group #3_203 is 1:1, a fairness of the output band may be secured.

Further, when the communication device #1_201 transmits data of the terminal group #1_203 addressed to the communication device #0_201, as well as the data of the terminal group #3_203 and the terminal group #2_203, which is addressed to the communication device #0_201, to the communication device #0_201, the transfer rate ratio of the terminal group #1 to the terminal group #2 to the terminal group #3 becomes 2:1:1. That is, the transfer rate ratio of the terminal group #1_203 is 50%, while the transfer rate ratio of each of the terminal group #2_203 and the terminal group #3_203 is 25%. Thus, at a lower stage, the ratio of the data amount transmittable in the uplink direction is reduced. As a result, a fairness of the output band of each communication device 201 within the communication system 200 may not be secured.

Therefore, in order to secure the fairness of the output band for each communication device 201, the maintainer of the communication system 200 needs to execute a band control considering the stack connection of the communication devices 201. As a result, the work burden on the maintainer is increased.

Hereinafter, detailed descriptions will be made on embodiments of a communication device, a communication system and a communication method, in which a fairness of output bands for communication devices with a stack connection is secured, with reference to drawings. Here, the disclosed technology is not limited to the embodiments. In addition, the following embodiments may be appropriately combined within a range that does not cause a contradiction.

### First Embodiment

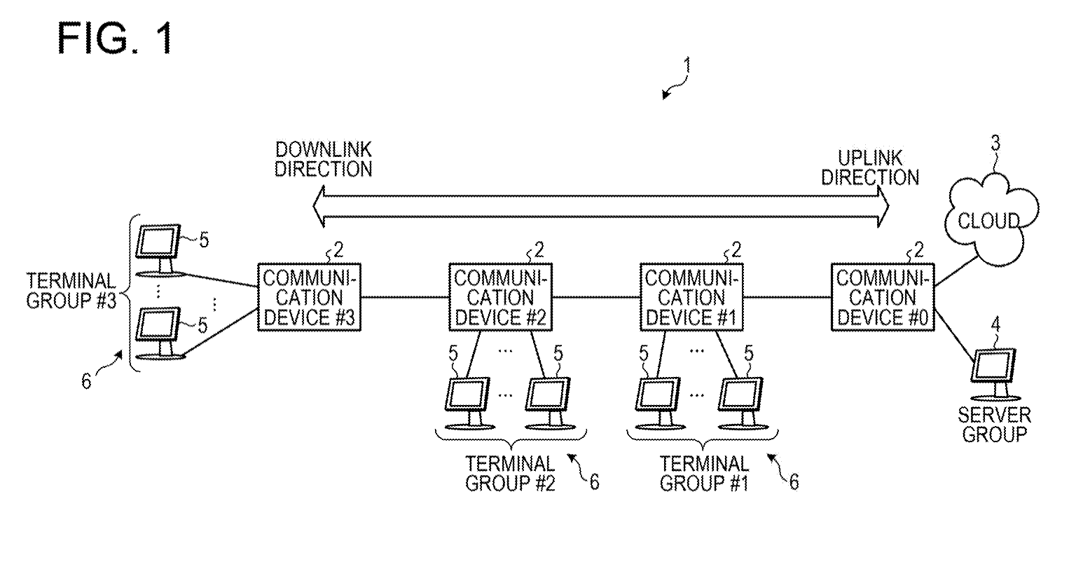

FIG. 1 is an explanatory view illustrating an example of a communication system 1 according to a first embodiment. The communication system 1 illustrated in FIG. 1 is configured by connecting a plurality of communication devices 2 in a stack. For example, a communication device #1_2 is connected under an upper-stage communication device #0_2, a communication device #2_2 is connected under the communication device #1_2, and a communication device #3_2 is connected under the communication device #2_2. The communication device 2 is, for example, an L2 switch. For convenience of explanation, a data direction from the communication device #0_2 to the communication device #3_2 via the communication devices #1_2 and #2_2 is assumed as a downlink direction, and a data direction from the communication device #3_2 to the communication device #0_2 via the communication devices #2_2 and #1_2 is assumed as an uplink direction.

The communication device #0_2 is assumed to be connected to, for example, a cloud 3 or a server group 4. The communication device #0_2 may be connected to the Internet as well as the cloud 3. The communication device #1_2 is connected to accommodate a terminal group #1_6 including a plurality of terminals 5. The terminal 5 is, for example, a client terminal. Further, the communication device #2_2 is connected to accommodate a terminal group #2_6 including a plurality of terminals 5. Further, the communication device #3_2 is connected to accommodate a terminal group #3_6 including a plurality of terminals 5.

For example, when transmitting data to the upper-stage communication device #0_2, the lowermost-stage communication device #3_2 transmits the data to the upper-stage communication device #2_2 in the uplink direction. The communication device #2_2 transmits the data to the upper-stage communication device #1_2 in the uplink direction. The communication device #1_2 transmits the data to the upper-stage communication device #0_2. That is, the communication device #0_2 may receive the data from the lowermost-stage communication device #3_2 via the communication devices #2_2 and #1_2.

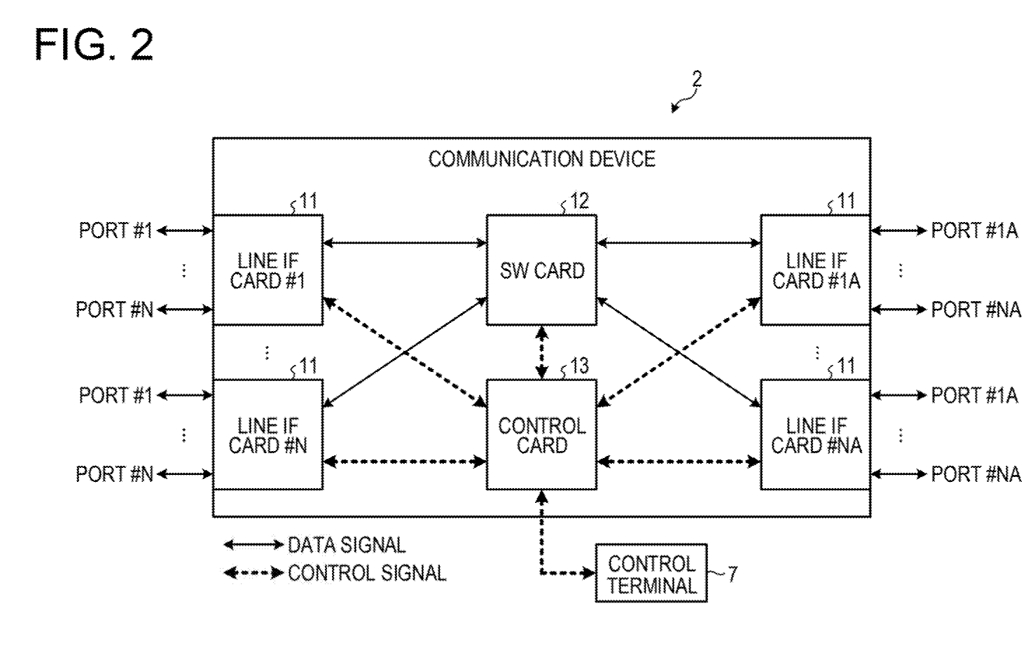

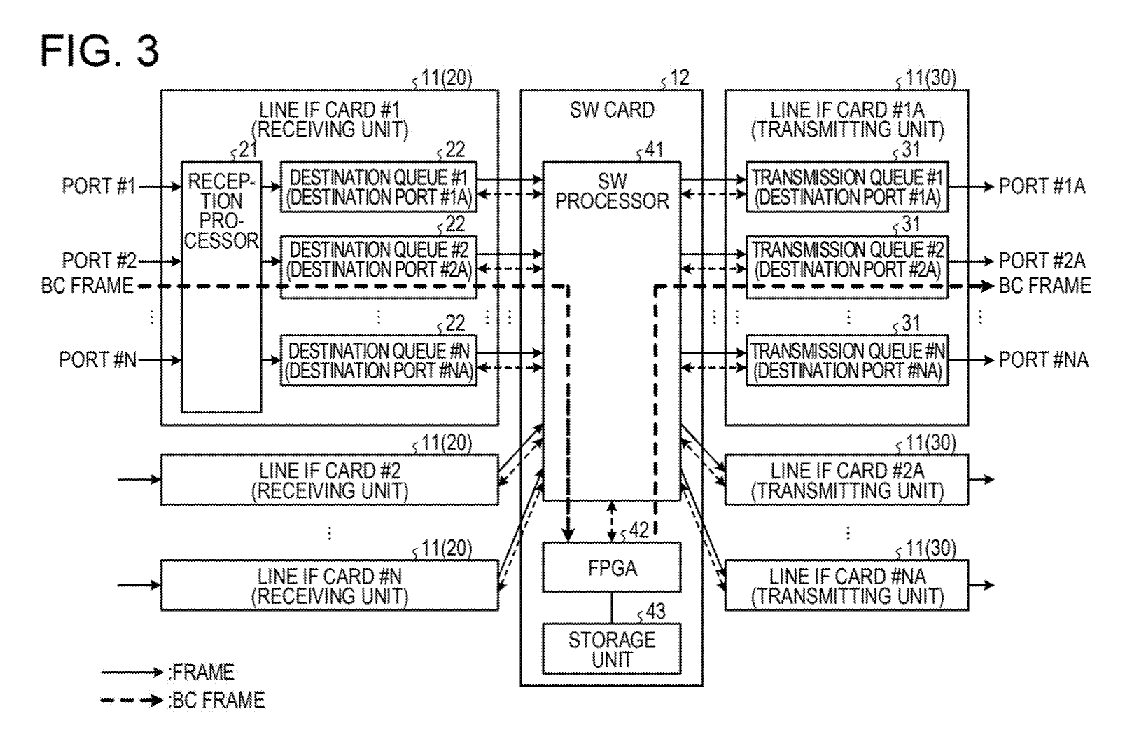

FIG. 2 is a block diagram illustrating an example of a card configuration within the communication device 2 according to the first embodiment. FIG. 3 is a block diagram illustrating an example of a configuration within the communication device 2. The communication device 2 illustrated in FIG. 2 includes a plurality of line IF cards 11, an SW card 12, and a control card 13 mounted therein. Each line IF card 11 is an IF card that accommodates a plurality of ports #1 to #N or a plurality of ports #1A to #NA, and connects lines to, for example, respective terminals 5 within the terminal group 6. Each line IF card 11 includes a receiving unit 20 that executes a frame reception processing and a transmitting unit 30 that executes a frame transmission processing. Here, the card means a circuit board.

The SW card 12 is a card incorporating a switch function that transmits data signals between the plurality of line IF cards 11 by switching connections between the line IF cards 11. The control card 13 is a card that controls the entire communication device 2 and also is in charge of various settings of each card within the communication device 2, and collection of alarms or statistical information. The control card 13 is connected to a control terminal 7 to change the settings of contents of various cards within the communication device 2 according to a setting operation from the control terminal 7. Furthermore, the control terminal 7 may collect alarms or statistical information through the control card 13.

The line IF cards 11, the SW card 12, and the control card 13 are cards detachable from slots within the communication device 2. For convenience of explanation, the line IF cards 11, the SW card 12 and the control card 13 within the communication device 2 are configured to be detachable from the slots within the communication device 2, but may be fixedly mounted in the communication device 2.

The receiving unit 20 within the line IF card 11 illustrated in FIG. 3 includes a reception processor 21 and a plurality of destination queues 22. The reception processor 21 is a processing unit that identifies frames received from the ports #1 to #N. The reception processor 21 is a processing unit that transmits a reception frame based on destination information within the reception frame such as, for example, a MAC address, an IP address, and the like.

The destination queue 22 is a queue arranged for each destination port and stores a reception frame corresponding to the destination port. The reception processor 21 specifies a destination port within the reception frame based on destination information within the reception frame and stores the reception frame in the destination queue 22 corresponding to the specified destination port. The transmitting unit 30 within the line IF card 11 includes a plurality of transmission queues 31. The transmission queue 31 is a queue that is provided for each destination port and stores a transmission frame for each destination port. The transmission queue 31 sequentially outputs stored frames in the order of arrival from the destination port.

The SW card 12 includes an SW processor 41, a field programmable gate array (FPGA) 42, and a storage unit 43. The SW processor 41 is a processing unit that switches a connection between the destination queue 22 and the transmission queue 31. The FPGA 42 controls the entire SW card 12. The storage unit 43 is a storage area that stores various kinds of information. The SW processor 41 and the FPGA 42 may function as a processor.

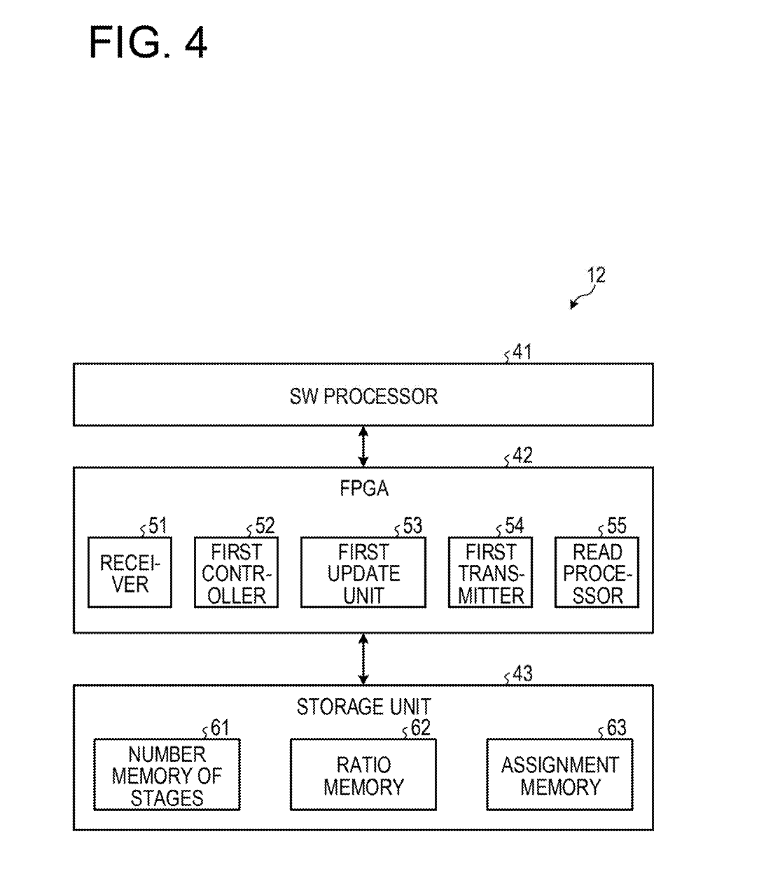

FIG. 4 is an explanatory view illustrating an example of a functional configuration within the SW card 12. The FPGA 42 illustrated in FIG. 4 includes, as a functional configuration, a receiver 51, a first controller 52, a first update unit 53, a first transmitter 54, and a read processor 55.

The receiver 51 acquires information on the stack stage number within a band control (BC) frame from the reception processor 21. Here, the BC frame stores the information on the stack stage number. The information on the stack stage number is information on the stack stage number of the subordinate communication devices 2, which is to be notified to the upper-stage communication device 2. The first controller 52 controls an output band based on the information on the stack stage number. The first controller 52 calculates a transfer rate ratio for each subordinate terminal group 6 based on the information on the stack stage number. Further, the first controller 52 calculates an allocation band amount for each terminal group 6 based on the calculated transfer rate ratio for each terminal group 6. Then, the first controller 52 controls the output band for each terminal group 6 based on the transfer rate ratio and the allocation band amount for each terminal group 6.

The first update unit 53 increments the stack stage number acquired from the BC frame, by +1, when its own device has an upper-stage communication device 2. When the own device is, for example, a communication device #1_2, the upper-stage communication device 2 becomes a communication device #0_2. When the own device is a communication device #2_2, the upper-stage communication device 2 becomes a communication device #1_2. The first transmitter 54 stores the stack stage number after the increment of +1 in the BC frame, and transmits the BC frame storing the stack stage number to the upper-stage communication device 2. The first transmitter 54 transmits the BC frame storing a stack stage number “1” for the upper-stage communication device 2, to the upper-stage communication device 2 at a predetermined cycle such as, for example, a cycle of one second. The first transmitter 54 transmits the BC frame with the stack stage number “1” to the upper-stage communication device 2 at a cycle of, for example, one second. Further, at a timing after reception of the BC frame from the lower-stage communication device 2, the first transmitter 54 transmits the BC frame including a stack stage number obtained by incrementing the stack stage number within the BC frame by +1, to the upper-stage communication device 2.

The read processor 55 controls reading of a frame of the destination queue 22 for each terminal group 6 based on the transfer rate ratio of each terminal group 6 being set. The read processor 55 reads the reception frame stored in each destination queue 22 based on the transfer rate ratio for each terminal group 6, transmits the read reception frame to the transmission queue 31 corresponding to a destination port which in turn corresponds to the destination queue 22, and stores the transmitted frame in the transmission queue 31.

The storage unit 43 includes a number memory of stages 61, a ratio memory 62, and an assignment memory 63. The number memory of stages 61 is an area that stores the number of stack stages subordinate to the own device within the communication system 1. The ratio memory 62 is an area that stores a transfer rate ratio of each terminal group 6. The assignment memory 63 is an area that stores an allocation band amount for each terminal group 6.

When acquiring the stack stage number by the receiver 51, the first controller 52 may recognize the number of stack stages of the terminal groups 6 subordinate to the own device based on the acquired stack stage number. Further, when acquiring the stack stage number, the first controller 52 compares the acquired stack stage number to the stack stage number stored in the number memory of stages 61. Then, when the acquired stack stage number is different from the stack stage number stored in the number memory of stages 61, the first controller 52 activates a measurement timer while holding the acquired stack stage number. Here, the cycle of the measurement timer is set as, for example, three times the predetermined cycle, that is, three seconds. When acquiring the stack stage number that is the same as the stack stage number held by the receiver 51 for the period of the measurement timer, the first controller 52 stores the held stack stage number to update the number memory of stages 61. When acquiring a plurality of stack stage numbers, it is assumed that the first controller 52 holds a maximum stack stage number among the plurality of stack stage numbers.

When the stack stage number is updated within the number memory of stages 61, the first update unit 53 increments the stack stage number within the received BC frame, by +1. Then, the first transmitter 54 stores the stack stage number after the increment of +1 within the BC frame, and transmits the BC frame to the upper-stage communication device 2.

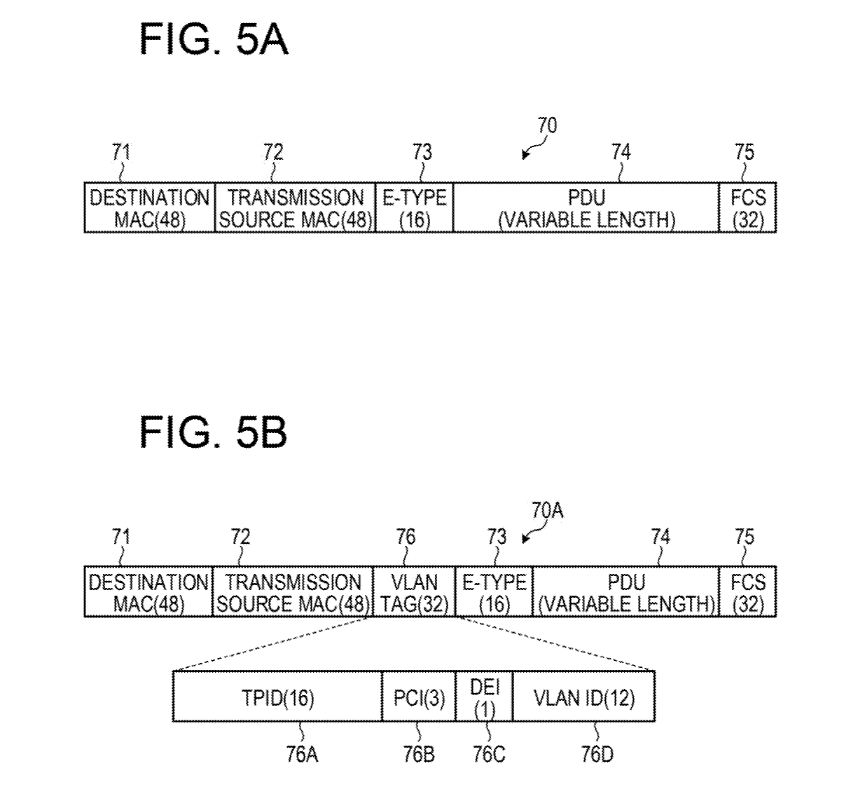

FIG. 5A is an explanatory view illustrating an example of a format configuration of a VLAN tagless frame, and FIG. 5B is an explanatory view illustrating an example of a format configuration of a VLAN tag frame. A VLAN tagless frame 70 illustrated in FIG. 5A includes a destination media access control (MAC) 71, a transmission source MAC 72, an E-TYPE 73, a protocol data unit (PDU) 74, and a frame check sequence (FCS) 75. The destination MAC 71 is a 48-bit area that stores a MAC address of a destination of the frame. The transmission source MAC 72 is a 48-bit area that stores a transmission source address of the frame. The E-TYPE 73 is a 16-bit area that identifies a type classification of the frame. The PDU 74 is a variable-length bit area including, for example, a header portion and a payload portion. The FCS 75 is a 32-bit area that stores checksum codes for error detection and correction.

A VLAN tag frame 70A illustrated in FIG. 5B includes a virtual local area network (VLAN) tag 76 as well as the destination MAC 71, the transmission source MAC 72, the E-TYPE 73, the PDU 74 and the FCS 75. The VLAN tag 76 includes a tag protocol identifier (TPID) 76A, a priority code indicator (PCI) 76B, a drop eligible indicator (DEI) 76C, and a VLANID 76D. The TPID 76A is a 16-bit area that stores an identifier for identifying a frame with a VLAN tag. The PCI 76B is a 3-bit area that stores an identifier for identifying priorities of eight classes for the frame. The DEI 76C is a 1-bit area that stores an identifier of a discard priority by which the frame is preferentially discarded at the time of congestion. The VLANID 76D is a 12-bit area that stores an identifier for identifying a VLAN user. The TPID 76A and the VLANID 76D are referred to as VLAN tags, and a plurality of VLANs may be continuously connected in a stack.

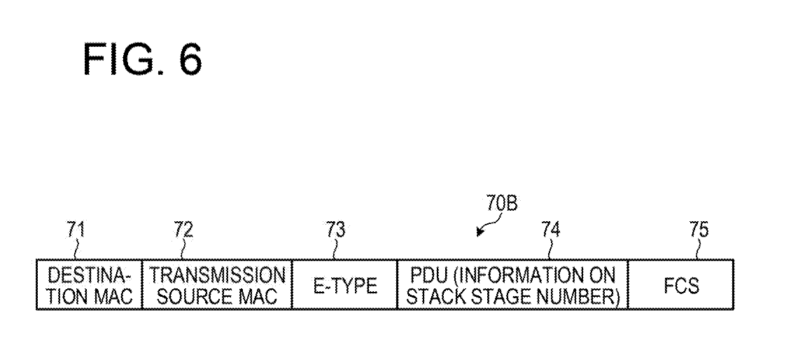

FIG. 6 is an explanatory view illustrating an example of a format configuration of a BC frame 70B. The BC frame 70B illustrated in FIG. 6 includes a destination MAC 71, a transmission source MAC 72, an E-TYPE 73, a PDU 74, and a FCS 75. It is assumed that the PDU 74 stores control information such as information on the stack stage number. Also, it is assumed that the E-TYPE 73 stores an arbitrary type classification by which the corresponding frame is identified as a BC frame.

The reception processor 21 specifies a destination port based on the destination MAC 71 within a reception frame, and identifies a BC frame based on the E-TYPE 73 within the reception frame. When identifying the corresponding frame as a BC frame, the reception processor 21 identifies information on the stack stage number within the PDU 74.

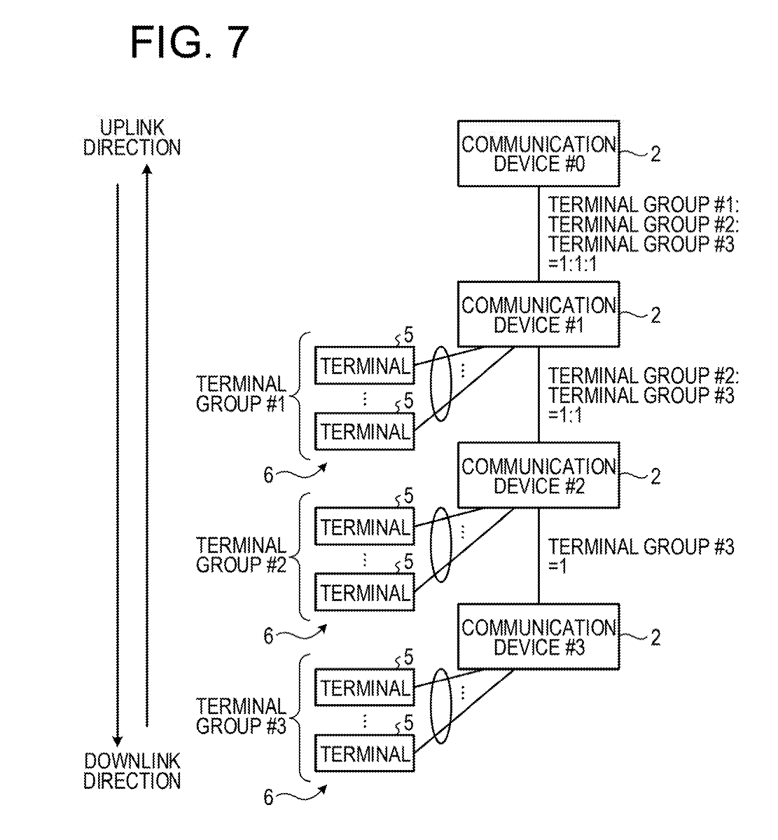

FIG. 7 is an explanatory view illustrating an example of setting contents of a transfer rate ratio for each communication device 2 within the communication system 1. When transmitting data of the terminal group #3_6 addressed to the communication device #0_2, the communication device #3_2 transmits the data of the terminal group #3_6 to the communication device #2_2.

The communication device #2_2 transmits data of the terminal group #2_6 addressed to the communication device #0_2, as well as the data of the terminal group #3_6 addressed to the communication device #0_2, to the communication device #1_2. Here, the communication device #2_2 sets the transfer rate ratio of the terminal group #2 to the terminal group #3 as 1:1 so that the data of the terminal groups #2_6 and #3_6 is equally transmitted to the communication device #1_2. As a result, the communication device #2_2 may equally transmit the data of the terminal groups #2_6 and #3_6 to the communication device #1_2 based on the transfer rate ratio.

Further, the communication device #1_2 transmits data of the terminal group #1_6 addressed to the communication device #0_2, as well as the data of the terminal groups #3_6 and #2_6 addressed to the communication device #0_2, to the communication device #0_2. Here, the communication device #1_2 sets the transfer rate ratio of the terminal group #1 to the terminal group #2 to the terminal group #3 as 1:1:1 so that the data of the terminal groups #1_6, #2_6 and #3_6 is equally transmitted to the communication device #0_2. As a result, the communication device #1_2 may equally transmit the data of the terminal groups #1_6, #2_6 and #3_6 to the communication device #0_2 based on the transfer rate ratio.

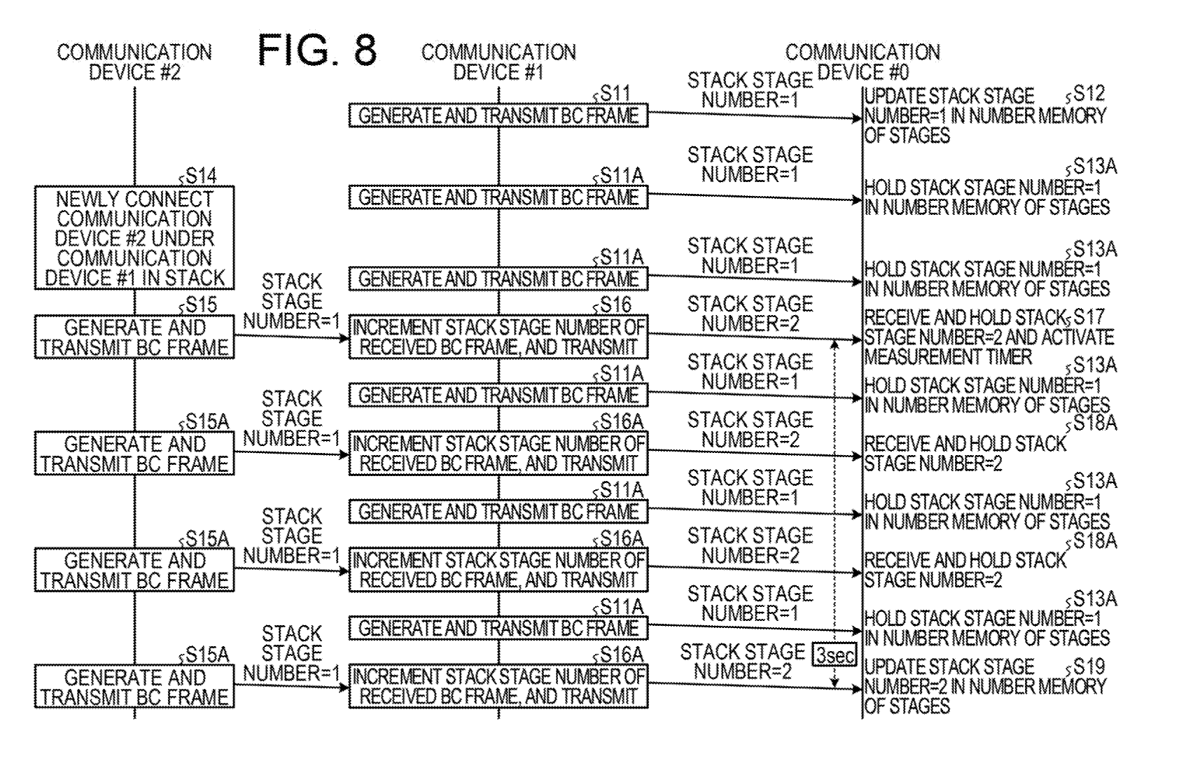

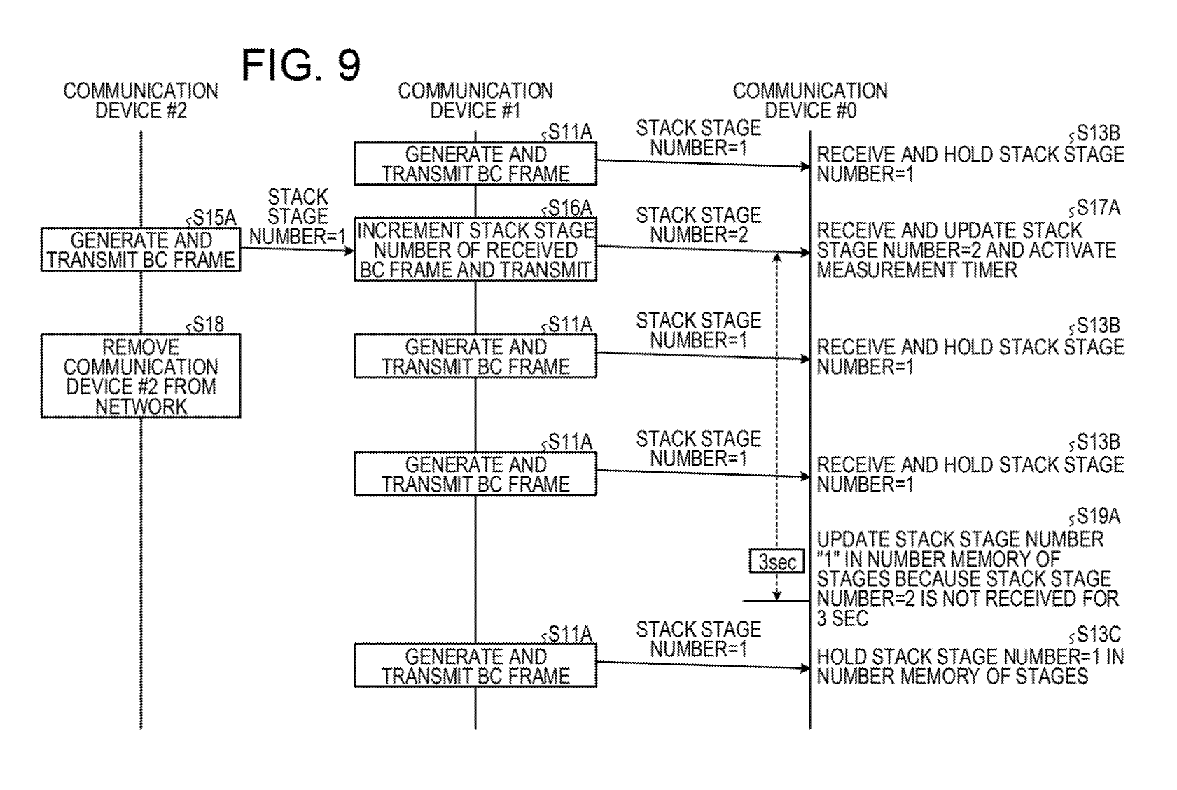

Subsequently, descriptions will be made on the operation of the communication system 1 according to the first embodiment. FIGS. 8 and 9 are sequence diagrams each illustrating an example of a processing operation of communication devices #0_2, #1_2, and #2_2 related to the stage number update process. For convenience of explanation, the example of FIGS. 8 and 9 illustrate a series of processing operations in a case where the communication device #2_2 is additionally connected under the communication device #1_2 in a state where the communication device #1_2 subordinate to the communication device #0_2 is connected to the communication device #0_2, and then the additional connection of the communication device #2_2 is removed.

The communication device #1_2 illustrated in FIG. 8 generates a BC frame with a stack stage number “1” and transmits the generated BC frame to the communication device #0_2 (sequence S11). When receiving the BC frame from the subordinate communication device #1_2, the communication device #0_2 updates the number memory of stages 61 with the stack stage number “1” within the BC frame (sequence S12). The communication device #1_2 sequentially transmits BC frames each having a stack stage number “1” to the communication device #0_2 at a cycle of, for example, one second (sequence S11A). Then, when sequentially receiving the BC frames from the communication device #1_2, the communication device #0_2 sequentially holds the stack stage number “1” within the BC frames, in the number memory of stages 61 (sequence S13A). Here, the holding the stack stage number indicates that the stack stage number stored in the number memory of stages 61 is held.

Thereafter, it is assumed that the communication device #2_2 is additionally connected under the communication device #1_2 (sequence S14). The communication device #2_2 generates a BC frame with a stack stage number “1”, and transmits the generated BC frame to the communication device #1_2 (sequence S15). When receiving the BC frame from the subordinate communication device #2_2, the communication device #1_2 increments the stack stage number “1” within the BC frame, by +1, and transmits the BC frame with a stack stage number “2” to the communication device #0_2 (sequence S16). When receiving the BC frame with the stack stage number “2” from the communication device #1_2, the communication device #0_2 compares the acquired stack stage number “2” to the stack stage number “1” stored in the number memory of stages 61. Then, the communication device #0_2 activates a measurement timer while holding the acquired maximum stack stage number “2” (sequence S17). Here, the timer time of the measurement timer is set as, for example, three seconds. The holding the stack stage number does not indicate that the stack stage number is stored in the number memory of stages 61 but indicates that the acquired stack stage number is held before being stored.

The communication device #2_2 sequentially transmits BC frames each having a stack stage number “1” to the communication device #1_2 at a cycle of one second (sequence S15A). Furthermore, each time the BC frame is received from the communication device #2_2, the communication device #1_2 sequentially transmits the BC frames each having a stack stage number “2” to the communication device #0_2 (sequence S16A). When receiving the BC frame with the stack stage number “2”, the communication device #0_2 holds the stack stage number “2” (sequence S18A).

When receiving the BC frame with the stack stage number “2” a plurality of times within a timer period of the measurement timer, the communication device #0_2 updates the number memory of stages 61 with the stack stage number “2” (sequence S19). As a result, in the number memory of stages 61 of the communication device #0_2, the stack stage number is updated from “1” to “2”.

When the stack stage number “2” is updated in the number memory of stages 61, the communication device #0_2 illustrated in FIG. 9 restarts the measurement timer (sequence S17A). The communication device #0_2 monitors the reception of the BC frame with the stack stage number “2” during the timer period of the measurement timer. Further, the communication device #0_2 continues to monitor the reception of the BC frame with the stack stage number “2” until the time is up for the measurement timer. The communication device #0_2 receives the BC frame with the stack stage number “2” during the period of the measurement timer, and then reactivates the measurement timer when the time is up for the measurement timer. The communication device #0_2 continues to monitor the reception of the BC frame with the stack stage number “2”.

Thereafter, it is assumed that the communication device #2_2 has been removed from being under the communication device #1_2 (sequence S18). In this case, the communication device #0_2 is not able to receive the BC frame with the stack stage number “2” from the communication device #1_2, and thus receives the BC frame with the stack stage number “1”, and holds the stack stage number “1” (sequence S13B). Then, the communication device #0_2 is not able to receive the BC frame with the stack stage number “2” during the timer period of the measurement timer restarting at sequence S17A, receives the BC frame with the stack stage number “1”, and holds the stack stage number “1” (sequence S13B).

As a result, when the BC frame with the stack stage number “2” was not received during the timer period of the measurement timer, the communication device #0_2 updates the number memory of stages 61 with the held stack stage number “1” (sequence S19A). In the number memory of stages 61, the stack stage number is updated from “2” to “1”. Then, each time the BC frame with the stack stage number “1” is received, the communication device #0_2 holds the stack stage number “1” in the number memory of stages 61 (sequence S13C).

The communication device 2 that executes the stage number update process acquires a stack stage number from the lower-stage communication device 2, compares the acquired stack stage number to a stack stage number within the number memory of stages 61, holds the acquired stack stage number, and activates the measurement timer. Then, when acquiring the same stack stage number as the held stack stage number during the timer period of the measurement timer, the communication device 2 updates the number memory of stages 61 with the held stack stage number. As a result, the communication device 2 may recognize the number of its subordinate stack stages.

The communication device 2 acquires the stack stage number from its subordinate communication device 2, and thus may recognize the number of subordinate stack stages even when an additional connection or connection removal of the subordinate communication device 2 occurs.

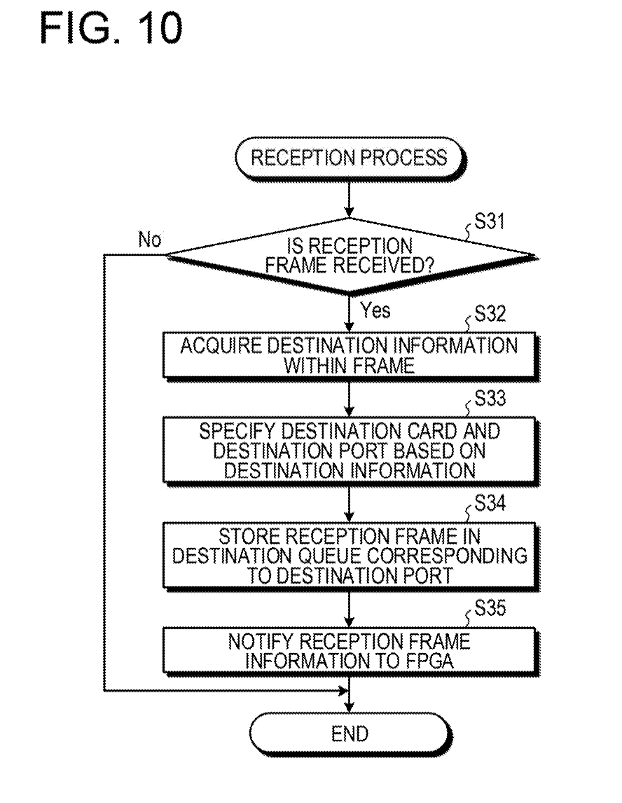

FIG. 10 is a flowchart illustrating an example of a processing operation of the reception processor 21 within the communication device 2 related to a reception process. The reception process illustrated in FIG. 10 is a process of storing a reception frame within a destination queue 22 corresponding to a destination port based on destination information within the reception frame.

In FIG. 10, the reception processor 21 determines whether a reception frame has been received through a destination port (operation S31). When it is determined that the reception frame has been received (“Yes” at operation S31), the reception processor 21 acquires destination information within the reception frame, such as, for example, a destination MAC (operation S32).

The reception processor 21 specifies a destination card and a destination port of the reception frame based on the destination information (operation S33). The reception processor 21 stores the reception frame in a destination queue 22 corresponding to the specified destination port (operation S34), notifies information on the reception frame to the FPGA 42 (operation S35), and ends the processing operation illustrated in FIG. 10. When it is determined that the reception frame has not been received (“No” at operation S31), the reception processor 21 ends the processing operation illustrated in FIG. 10.

In the reception process illustrated in FIG. 10, the destination card and the destination port are specified based on the destination information within the reception frame, and the reception frame is stored within the destination queue 22 corresponding to the specified destination card and destination port. As a result, the communication device 2 may store the reception frame within the destination queue 22 corresponding to the destination.

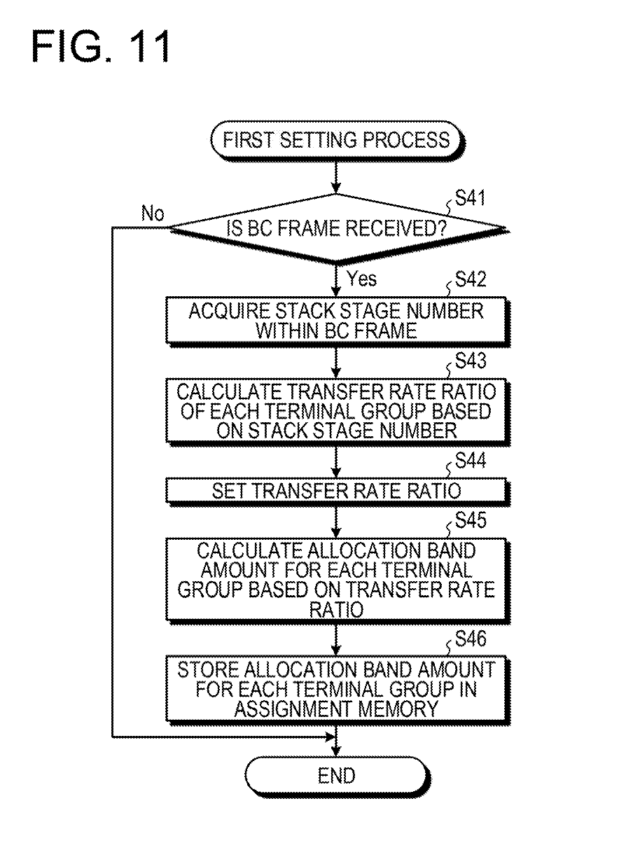

FIG. 11 is a flowchart illustrating an example of a processing operation of the FPGA 42 within the communication device 2 related to a first setting process. The first setting process illustrated in FIG. 11 is a process of setting a transfer rate ratio and an allocation band amount for each terminal group 6 based on a stack stage number acquired from a subordinate communication device 2.

In FIG. 11, the receiver 51 within the FPGA 42 determines whether a BC frame has been received (operation S41). When it is determined that the BC frame has been received (“Yes” at operation S41), the receiver 51 acquires a stack stage number within the BC frame (operation S42).

The first controller 52 within the FPGA 42 calculates a transfer rate ratio of each terminal group 6 based on the acquired stack stage number (operation S43), and sets the calculated transfer rate ratio (operation S44). Further, the first controller 52 calculates a transfer rate ratio so that transfer rates of respective terminal groups 6 are equalized, and stores the calculated transfer rate ratio of each terminal group 6 in the ratio memory 62. The first controller 52 calculates an allocation band amount for each terminal group 6 based on the stored transfer rate ratio (operation S45), stores the calculated allocation band amount for each terminal group 6 in the assignment memory 63 (operation S46), and ends the processing operation illustrated in FIG. 11. When it is determined that the BC frame has not been received (“No” at operation S41), the receiver 51 ends the processing operation illustrated in FIG. 11.

The first controller 52 that executes the first setting process calculates a transfer rate ratio of each terminal group 6 based on the stack stage number acquired from the subordinate communication device 2, and sets the calculated transfer rate ratio. As a result, the first controller 52 may set an allocation band amount for each terminal group 6 corresponding to the transfer rate ratio being set.

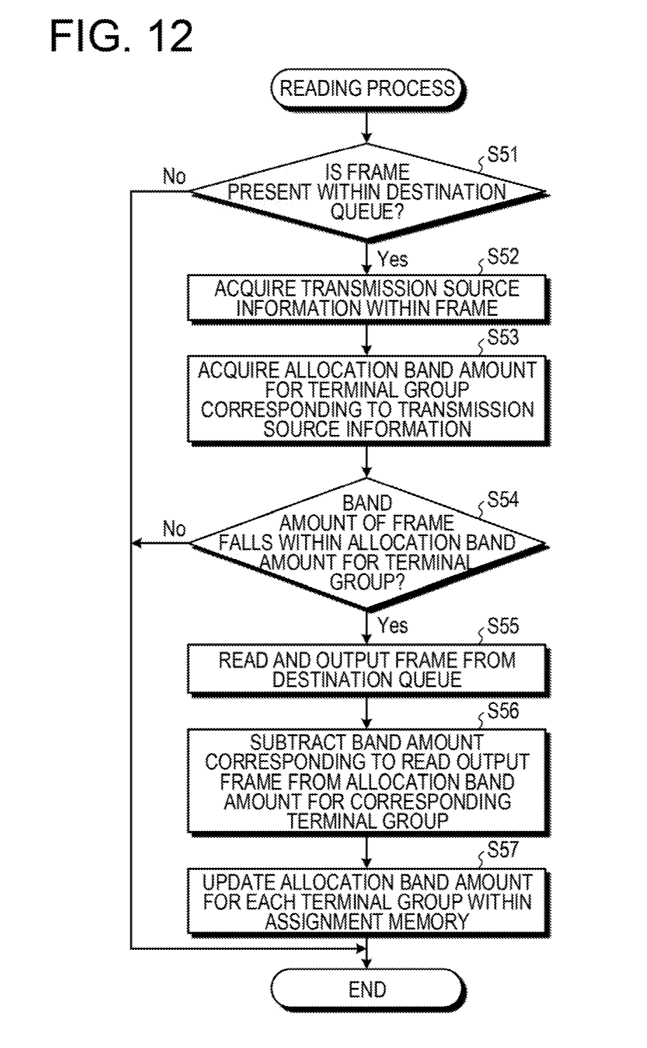

FIG. 12 is a flowchart illustrating an example of a processing operation of the FPGA 42 within the communication device 2 related to a reading process. The reading process illustrated in FIG. 12 is a process of controlling an output band of each terminal group 6 based on the transfer rate ratio being set.

In FIG. 12, the read processor 55 within the FPGA 42 determines whether a frame is present within the destination queue 22 (operation S51). When it is determined that a frame is present within the destination queue 22 (“Yes” at operation S51), the read processor 55 acquires transmission source information, such as a transmission source MAC, within the frame (operation S52).

The read processor 55 acquires an allocation band amount for a terminal group 6 corresponding to the acquired transmission source information (operation S53), and determines whether a band amount of the frame falls within the allocation band amount for the terminal group 6 of the frame (operation S54).

When it is determined that the band amount of the frame falls within the allocation band amount for the terminal group 6 of the frame (“Yes” at operation S54), the read processor 55 reads the frame from the destination queue 22, and outputs the read frame (operation S55). The read processor 55 subtracts a band amount corresponding to the read output frame from the allocation band amount for the terminal group 6 within the assignment memory 63 (operation S56), updates the allocation band amount for each terminal group 6 within the assignment memory 63 (operation S57), and ends the processing operation illustrated in FIG. 12.

When it is determined that a frame is not present within the destination queue 22 (“No” at operation S51), the read processor 55 ends the processing operation illustrated in FIG. 12. When it is determined that the band amount of the frame does not fall within the allocation band amount for the terminal group 6 of the frame (“No” at operation S54), the read processor 55 ends the processing operation illustrated in FIG. 12.

When there is a reception frame within the destination queue 22, the read processor 55 acquires an allocation band amount for a terminal group 6 corresponding to transmission source information within the reception frame. When the band amount of the reception frame falls within the allocation band amount for the terminal group 6, the read processor 55 outputs a reception frame within the destination queue 22. As a result, the communication device 2 may control an output band of each terminal group 6 based on the allocation band amount for each terminal group 6.

The communication device 2 according to the first embodiment calculates a transfer rate ratio based on the stack stage number from its subordinate communication device 2, so that transfer rates of respective terminal groups 6 are equalized, and controls an output band amount of each terminal group 6 based on the calculated transfer rate ratio. As a result, a fairness of the output band of each terminal group 6 may be secured even when the communication devices 2 are connected in a stack.

The communication device 2 receives a BC frame including a stack stage number from its subordinate communication device 2, and thus may recognize the number of stack stages of the subordinate communication devices 2. The communication device 2 recognizes the number of stack stages of the subordinate communication devices 2, and thus may autonomously control an output band even when the addition, removal, or failure of the communication device 2 occurs. This may reduce a work burden on the maintainer of the communication device 2.

The communication device 2 according to the first embodiment controls an output band amount of each terminal group 6 based on a stack stage number from its subordinate communication device 2. However, instead of the stack stage number, a maximum rate amount for each terminal group may be adopted, and an embodiment thereof as a second embodiment will be described below.

### Second Embodiment

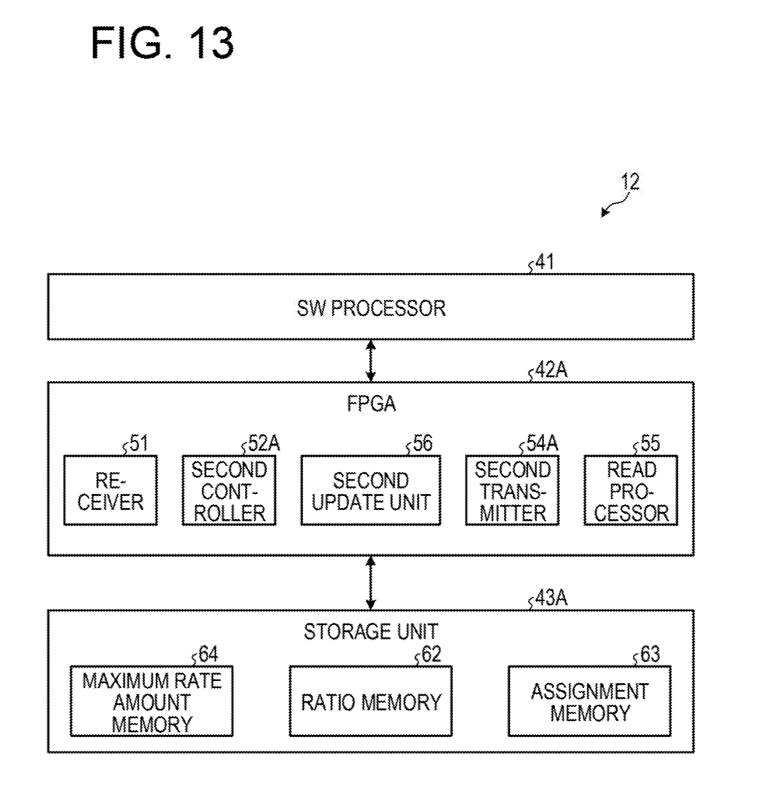

FIG. 13 is an explanatory view illustrating an example of a functional configuration within the SW card 12 in the communication device 2 according to a second embodiment. The same components as those of the communication device 2 according to the first embodiment are denoted by the same reference numerals, and duplicate descriptions of the configuration and operation thereof are omitted.

An FPGA 42A within the SW card 12 illustrated in FIG. 13 includes a second controller 52A instead of the first controller 52, a second update unit 56 instead of the first update unit 53, and a second transmitter 54A instead of the first transmitter 54. Further, a storage unit 43A includes a maximum rate amount memory 64 that stores a maximum rate amount of each terminal group 6, instead of the number memory of stages 61. The SW processor 41 and the FPGA 42A may function as a processor.

The second controller 52A calculates a transfer rate ratio of each terminal group 6 based on a maximum rate amount of each terminal group 6. The second controller 52A stores the calculated transfer rate ratio of each terminal group 6 in a ratio memory 62. The second controller 52A controls an output band amount of each terminal group 6 based on the transfer rate ratio of each terminal group 6. The second controller 52A calculates an allocation band amount for each terminal group 6 based on the transfer rate ratio of each terminal group 6. The second controller 52A stores the allocation band amount for each terminal group 6, in an assignment memory 63.

When an own device has an upper-stage communication device 2, the second update unit 56 adds a maximum rate amount of a terminal group 6 accommodated by the own device to a maximum rate amount of a terminal group 6 acquired from a BC frame. The second transmitter 54A adds the maximum rate amount of the terminal group 6 accommodated by the own device, stores the maximum rate amount of each terminal group 6 within the BC frame, and transmits the BC frame storing the maximum rate amount to the upper-stage communication device 2. The second transmitter 54A transmits, for example, a BC frame including a maximum rate amount of a terminal group 6 accommodated by the own device as well as a maximum rate amount of a terminal group 6 from a lower-stage communication device 2, to an upper-stage communication device 2.

The maximum rate amount memory 64 is an area that stores a maximum rate amount of each terminal group 6 stored in a BC frame as well as a maximum rate amount of a terminal group 6 accommodated by an own device.

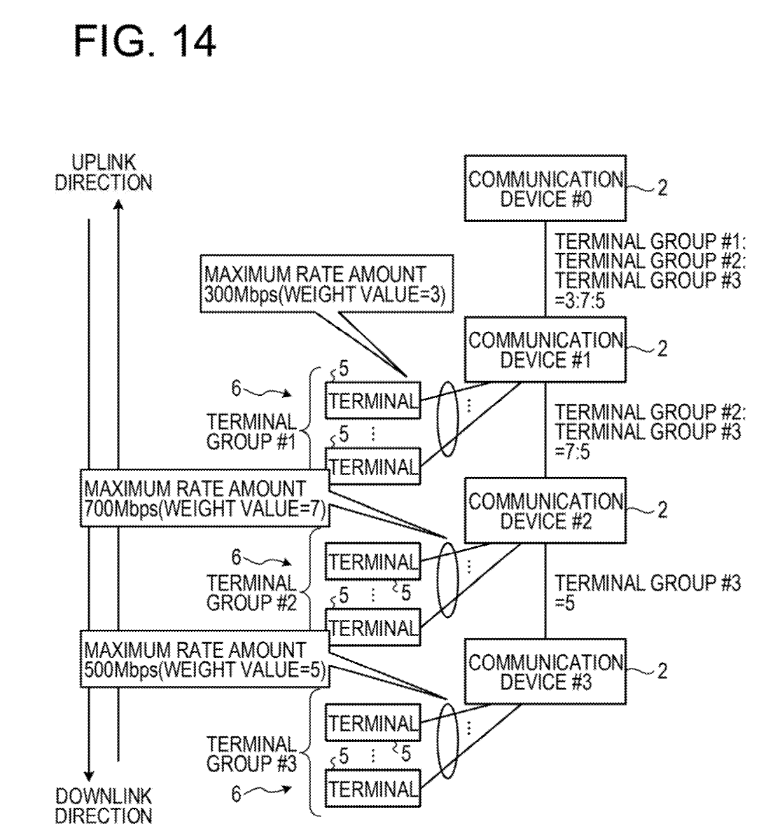

FIG. 14 is an explanatory view illustrating an example of setting contents of a transfer rate ratio for each communication device 2 within the communication system 1 according to the second embodiment. It is assumed that the terminal group #3_6 has a maximum rate amount of 500 Mbps, and a weight value of 5, the terminal group #2_6 has a maximum rate amount of 700 Mbps, and a weight value of 7, and the terminal group #1_6 has a maximum rate amount of 300 Mbps, and a weight value of 3.

The communication device #3_2 allocates a band amount in which the terminal group #3_6 has a maximum rate amount of 500 Mbps, with respect to the communication device #2_2. The communication device #2_2 sets a ratio (7:5) of the maximum rate amount (700 Mbps) of the terminal group #2_6 to the maximum rate amount (500 Mbps) of the terminal group #3_6 as a transfer rate ratio with respect to the allocation band amount for the communication device #1_2.

The communication device #1_2 sets a ratio (3:7:5) of the maximum rate amount (300 Mbps) of the terminal group #1_6 to the maximum rate amount (700 Mbps) of the terminal group #2_6 to the maximum rate amount (500 Mbps) of the terminal group #3_6 as a transfer rate ratio with respect to the communication device #0_2. The communication device #1_2 may efficiently transmit data of the terminal groups #1_6, #2_6 and #3_6 to the communication device #0_2 according to a demand based on the transfer rate ratio of the terminal group #1 to the terminal group #2 to terminal group #3 of 3:7:5.

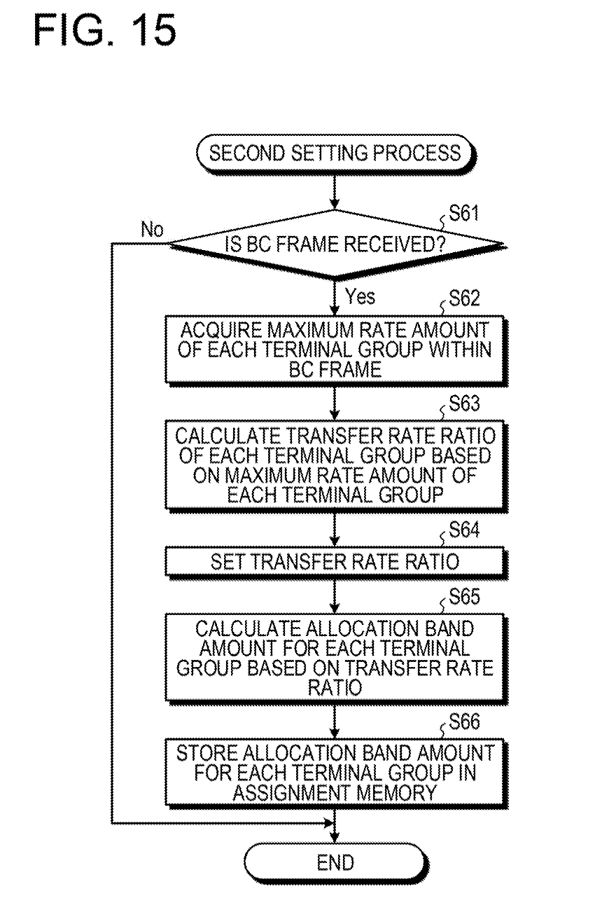

FIG. 15 is a flowchart illustrating an example of a processing operation of the FPGA 42A within the communication device 2 related to a second setting process. The second setting process illustrated in FIG. 15 is a process of setting a transfer rate ratio and an allocation band amount for each terminal group 6 based on the maximum rate amount of each terminal group 6 acquired from the subordinate communication device 2.

In FIG. 15, the receiver 51 within the FPGA 42A determines whether a BC frame has been received (operation S61). When it is determined that the BC frame has been received (“Yes” at operation S61), the receiver 51 acquires a maximum rate amount of each terminal group 6 within the BC frame (operation S62).

The second controller 52A within the FPGA 42A calculates a transfer rate ratio of each terminal group 6 based on the acquired maximum rate amount of each terminal group 6 (operation S63), and sets the calculated transfer rate ratio (operation S64). The second controller 52A calculates an allocation band amount for each terminal group 6 based on the transfer rate ratio (operation S65), stores the calculated allocation band amount for each terminal group 6 in the assignment memory 63 (operation S66), and ends the processing operation illustrated in FIG. 15. When it is determined that the BC frame has not been received (“No” at operation S61), the receiver 51 ends the processing operation illustrated in FIG. 15.

The second controller 52A that executes the second setting process calculates a transfer rate ratio of each terminal group 6 based on the maximum rate amount of each terminal group 6 acquired from the subordinate communication device 2, and sets the calculated transfer rate ratio. As a result, the second controller 52A may set an allocation band amount for each terminal group 6 corresponding to the transfer rate ratio being set.

The communication device 2 according to the second embodiment calculates, based on the maximum rate amount of each terminal group 6 from its subordinate communication device 2, a transfer rate ratio of each terminal group 6 in which the maximum rate amount is reflected, and controls an output band amount of each terminal group 6 based on the calculated transfer rate ratio. As a result, a fairness of the output band of each terminal group 6 may be secured and resources of the output band may be effectively utilized even when the communication devices 2 are connected in a stack.

In the frame 70B illustrated in FIG. 6, an identifier indicating that the corresponding frame is the BC frame 70B is defined in an arbitrary E-TYPE among the E-TYPEs 73. However, the identifier indicating that the corresponding frame is a BC frame may be defined in an arbitrary VLANID among VLANIDs within the frame instead of the E-TYPE. The identifier indicating that the corresponding frame is a BC frame may be defined in an arbitrary destination MAC among destination MACs within the frame.

In the present embodiment, an Ether frame is exemplified as a frame to be transmitted within the communication system 1, but the embodiment may be equally applicable to an Internet protocol (IP) frame, a multi-protocol label switching (MPLS) frame, or a packet or the like.

When the band amount of the frame does not fall within the allocation band amount for the terminal group 6 at operation S54, the read processor 55 is set to end the processing operation illustrated in FIG. 12, but may adjust allocation band amounts between terminal groups 6.

In the communication device 2 according to the embodiment as described above, one terminal group 6 is accommodated and connected, but a plurality of terminal groups 6 may be accommodated and connected. The communication device 2 may set a transfer rate ratio of each terminal group 6. In the communication device 2, a transfer rate ratio is set for each terminal group 6, but may be set for each communication device 2. The communication system 1 employs a configuration in which the communication devices 2 are connected in series, as an example, but may also employ, for example, a mesh configuration in which the plurality of communication devices 2 are connected.

In the communication device 2 according to the first embodiment, a transfer rate ratio of each terminal group 6 is calculated based on a stack stage number. In the communication device 2 according to the second embodiment, a transfer rate ratio of each terminal group 6 is calculated based on a maximum rate amount of each terminal group 6. However, the communication device 2 may calculate a transfer rate ratio of each terminal group 6 based on the stack stage number and the maximum rate amount of each terminal group 6. For example, the communication device 2 may calculate a transfer rate ratio of each terminal group 6 based on the stack stage number, and furthermore, may dynamically adjust the calculated transfer rate ratio of each terminal group 6 based on the maximum rate amount of each terminal group 6.

The illustrated respective components of each unit are not necessarily physically configured as illustrated in the drawings. That is, the specific forms of distribution and integration of respective units are not limited to those illustrated in the drawings, but all or a part thereof may be distributed or integrated functionally or physically in arbitrary units according to various loads, usage situations or the like.

Furthermore, all or an arbitrary part of various processing functions performed by the respective devices may be executed on a central processing unit (CPU), a digital signal processor (DSP), a field programmable gate array (FPGA) or the like. All or an arbitrary part of the various processing functions may be executed by a program analyzed and executed by a CPU or the like, or hardware using a wired logic.

An area that stores various types of information may be configured with, for example, a read only memory (ROM), or a random access memory (RAM) such as a synchronous dynamic random access memory (SDRAM), a magnetoresistive random access memory (MRAM) or a non-volatile random access memory (NVRAM).

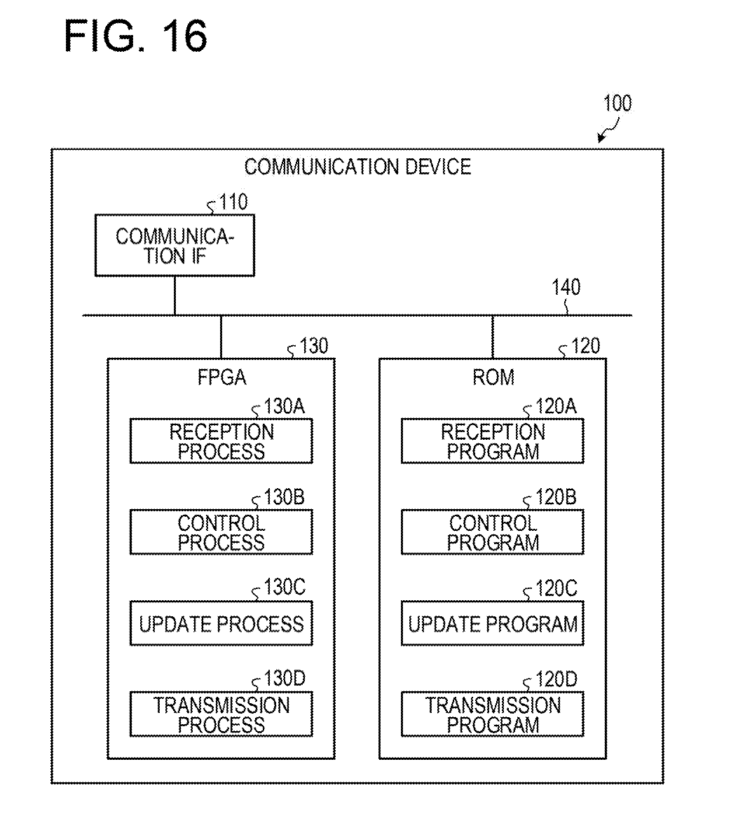

Meanwhile, various processes described in the present embodiments may be realized by executing a previously prepared program in an FPGA or the like within a communication device. Therefore, hereinafter, descriptions will be made on an example of a communication device that executes a program having the same functions as those of the above described embodiments. FIG. 16 is an explanatory view illustrating an example of a communication device 100 that executes a communication program.

The communication device 100 that executes the communication program, as illustrated in FIG. 16, includes a communication IF 110, a ROM 120, an FPGA 130, and a bus 140. The communication IF 110, the ROM 120 and the FPGA 130 are connected through the bus 140. The communication IF 110 is communicated with another communication device within a communication network.

In the ROM 120, a communication program that exhibits the same functions as those of the above described embodiments is stored in advance. In the ROM 120, a reception program 120A, a control program 120B, an update program 120C, and a transmission program 120D are stored as communication programs. The communication programs may be recorded in a computer-readable recording medium with a drive (not illustrated) instead of the ROM 120. As for the recording medium, for example, a portable recording medium such as a CD-ROM, a DVD disk, a USB memory or the like, or a semiconductor memory such as a flash memory may be used.

The FPGA 130 reads the reception program 120A from the ROM 120, and functions as a reception process 130A. The FPGA 130 reads the control program 120B from the ROM 120, and functions as a control process 130B. The FPGA 130 reads the update program 120C from the ROM 120, and functions as an update process 130C. The FPGA 130 reads the transmission program 120D from the ROM 120, and functions as a transmission process 130D.

The FPGA 130 receives a control signal from a first communication device to be connected. The FPGA 130 controls an output band of the communication device based on a weight value in the received control signal. The FPGA 130 updates the weight value in the received control signal. The FPGA 130 transmits a control signal including the updated weight value to a second communication device to be connected. As a result, a fairness of the output band of each communication device may be ensured at the time of multi-stage connection.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A communication device in a communication system in which a plurality of communication devices are coupled in series, the communication device comprising:
a memory;
a processor coupled with the memory and the processor configured to:
receive a control signal included in a signal transmitted from a first communication device of the plurality of communication devices,
control an output band in which the communication device transmits the signal, based on a weight value included in the control signal received,
update the weight value, and
transmit the signal including the control signal including the weight value updated, to a second communication device of the plurality of communication devices through the output band controlled.

2. The communication device according to claim 1,
wherein the weight value is a value for indicating a stage number in order of an arrangement from a starting communication device of an uplink direction in the communication system.

3. The communication device according to claim 1,
wherein the control signal includes information of a first band width allocated within each of the first communication device and a lower-stage communication device subordinate to the first communication device, and
wherein the processor controls the output band, based on the information of the first band width and a second band width allocated within the communication device.

4. A communication system comprising:
a plurality of communication devices coupled in series,
wherein a first communication device of the plurality of communication devices transmits a signal including a control signal to a second communication device of the plurality of communication devices that transmits the signal to a third communication device of the plurality of communication devices, and
wherein the second communication device includes:
a memory,
a processor coupled with the memory and the processor configured to:
receive the control signal included in the signal from the first communication device,
control an output band in which the communication device transmits the signal, based on a weight value included in the control signal received,
update the weight value, and
transmit the signal including the control signal including the weight value updated, to the third communication device through the output band controlled.

5. A communication method of a communication device in a communication system in which a plurality of communication devices are coupled in series, the communication method comprising:
receiving a control signal included in a signal transmitted from a first communication device of the plurality of communication devices;
controlling an output band in which the communication device transmits the signal, based on a weight value included in the control signal received;
updating the weight value; and
transmitting the signal including the control signal including the weight value updated, to a second communication device of the plurality of communication devices through the output band controlled, by a processor.
